(19) United States
(12) Patent Application Publication
(10) Pub. No.: US 2026/0060314 A1
(43) Pub. Date: Mar. 5, 2026

(54) ATOMIZER AND ATOMIZATION DEVICE

(71) Applicant: SHENZHEN GEEKVAPE TECHNOLOGY CO., LTD., Shenzhen (CN)

(72) Inventor: Deli Wu, Shenzhen (CN)

(21) Appl. No.: 19/315,711

(22) Filed: Sep. 1, 2025

(30) Foreign Application Priority Data
Sep. 4, 2024 (CN) 202422177824.8
Oct. 9, 2024 (CN) 202422438433.7
Oct. 18, 2024 (CN) 202422538224.X

(51) Int. Cl. A24F 40/485; A24F 40/10; A24F 40/42; A24F 40/44; A24F 40/46; A24F 40/57; H05B 3/22

(52) U.S. Cl. CPC A24F 40/485; A24F 40/10; A24F 40/42; A24F 40/44; A24F 40/46; A24F 40/57; H05B 3/22

(57) ABSTRACT

The present application relates to the technical field of electronic atomization. Provided herein are an atomizer and an atomization device. The atomizer comprises a housing, an atomization core assembly, and a transition shell. Since the atomization device possesses an activated state and an inactivated state, the liquid storage chamber communicates with the interior of the atomization core assembly in the activated state, while being isolated from it in the inactivated state. During transportation of the atomizer, isolation between the liquid storage chamber and the atomization core assembly—achieving liquid-core separation—effectively prevents leakage of the atomization matrix through the atomization core assembly. When the atomizer is in use, activation establishes liquid-core contact, enabling the liquid storage chamber to continuously supply the atomization matrix, thereby ensuring normal operation of the atomizer and ultimately enhancing user experience.

### CROSS-REFERENCE TO RELATED APPLICATIONS

The present application claims the priority of Chinese Patent Application No. 202422177824.8, filed on Sep. 4, 2024, Chinese Patent Application No. 202422438433.7, filed on Oct. 9, 2024, Chinese Patent Application No. 202422538224.X, filed on Oct. 18, 2024, which are hereby incorporated by reference in their entirety.

### TECHNICAL FIELD

The present application relates to the technical field of electronic atomization, and specifically to atomizers and atomization devices.

### BACKGROUND OF THE DISCLOSURE

Existing atomization devices atomize the atomization matrix based on the heat-not-burn principle to form an aerosol for user consumption. Due to the atomization device comprising multiple interconnected components, poor sealing may occur, especially where the component storing the atomization matrix is interconnected with other components. During transportation, it is very likely that the atomization matrix will leak due to poor sealing, thus adversely affecting user experience.

Currently, the atomization device typically includes a housing, an atomizer and a power supply assembly. The atomizer and the power supply assembly are installed in the housing. The atomizer includes an atomization core assembly and is provided with a liquid storage chamber for storing the atomization matrix. The atomization core assembly includes an atomization tube and an atomizing core disposed within the atomization tube. The atomization tube is provided with an inlet hole communicating with the liquid storage chamber. The atomizing core can absorb the atomization matrix that enters the atomization tube through the inlet hole and, when energized by the voltage supplied by the power supply assembly, generate heat to atomize the atomization matrix, thereby forming an aerosol.

Since the atomization tube and the liquid storage chamber are in fluid communication via the inlet hole, the atomization matrix in the liquid storage chamber may flow into the atomization tube via the inlet hole during transportation, resulting in leakage.

### SUMMARY OF THE DISCLOSURE

The present application provides an atomizer and an atomization device. By implementing liquid-core separation, leakage of the atomization matrix is effectively prevented, thereby solving the problem of liquid leakage during transportation of the atomizer, and thus significantly improving user experience.

According to a first aspect, an atomizer disclosed herein includes:
a housing, having a liquid storage chamber and a first mounting chamber therein, the liquid storage chamber being configured to store an atomization matrix;
an atomization core assembly, disposed within the first mounting chamber and configured to heat the atomization matrix to form an aerosol; and
a transition shell, at least a portion thereof being disposed within the housing and sleeved around the atomization core assembly;
wherein the atomizer is operable between an activated state and an inactivated state: in the activated state, the liquid storage chamber is in communication with the atomization core assembly; in the inactivated state, the liquid storage chamber is isolated from the atomization core assembly.

According to a second aspect, an atomizer disclosed herein includes:
a housing, having a first end and a second end along its axial direction, wherein the first end is provided with an aerosol outlet, the housing comprises a transition shell disposed at the second end, the transition shell is provided with a first positioning structure and a second positioning structure spaced apart from each other along the axial direction of the housing; and
an atomization core assembly, axially movably engaged onto the transition shell; wherein the atomization core assembly, the transition shell, and the housing collectively enclose a liquid storage chamber; the atomization core assembly comprises an atomization tube provided with a liquid inlet capable of communicating with the liquid storage chamber; the atomization tube sealingly communicates with the aerosol outlet; the atomization core assembly is configured to heat an atomization matrix in the atomization tube to generate an aerosol; the atomization core assembly is provided with a fixing structure configured to engage with the first positioning structure and the second positioning structure;
wherein the atomization core assembly has a first mounted position and a second mounted position relative to the housing; when in the first mounted position, the fixing structure is engaged and secured with the first positioning structure, and the liquid inlet is sealed by the transition shell; when in the second mounted position, the fixing structure is engaged and secured with the second positioning structure, and the liquid inlet is in communication with the liquid storage chamber; the atomization core assembly is switchable from the first mounted position to the second mounted position.

According to a third aspect, an atomization device disclosed herein includes: a power supply assembly and the atomizer mentioned above.

According to the atomizer in the above embodiments, the atomizer includes a housing, an atomization core assembly and a transition shell. Since the atomization device has an activated state and an inactivated state, in the activated state, the liquid storage chamber and the atomization core assembly are connected, and in the inactivated state, the liquid storage chamber and the atomization core assembly are isolated. During transportation of the atomizer, the liquid storage chamber and the atomization core assembly are isolated, that is, liquid-core separation is achieved, which can prevent the atomization matrix from leaking through the atomization core assembly. When the atomizer is in use, the liquid-core contact is achieved by activating the atomizer, and the liquid storage chamber can continuously provide the atomization matrix to ensure the normal operation of the atomizer, thereby enhancing user experience.

### BRIEF DESCRIPTION OF THE DRAWINGS

FIG. 1 is a cross-sectional view of an atomizer according to an embodiment;

FIG. 2 is a schematic diagram of an atomizer according to an embodiment;

FIG. 3 is an exploded view of an atomizer according to an embodiment;

FIG. 4 is a schematic diagram of a transition shell according to an embodiment;

FIG. 5 is a schematic diagram of a driving member according to an embodiment;

FIG. 6 is a cross-sectional view showing a liquid-core separated state of an atomizer according to an embodiment;

FIG. 7 is a cross-sectional view showing a liquid-core contacted state of an atomizer according to an embodiment;

FIG. 8 is a schematic diagram of an atomizer according to another embodiment;

FIG. 9 is a cross-sectional view of an atomizer with the atomization core assembly positioned at a first mounting position according to another embodiment;

FIG. 10 is a cross-sectional view of an atomizer with the atomization core assembly positioned at a second mounting position according to another embodiment (View 1);

FIG. 11 is a cross-sectional view of an atomizer with the atomization core assembly positioned at a second mounting position according to yet another embodiment (View 2);

FIG. 12 is a schematic diagram of an atomization device according to another embodiment;

FIG. 13 is a cross-sectional view of an atomization device with the power supply assembly at a transition position according to another embodiment;

FIG. 14 is an enlarged view of the power supply assembly in FIG. 13;

FIG. 15 is a cross-sectional view of an atomization device with the power supply assembly at an operational position according to another embodiment;

FIG. 16 is a partial cross-sectional view of an atomizer according to a further embodiment of the present application;

FIG. 17 is a perspective view of a partial atomizer structure according to a further embodiment of the present application;

FIG. 18 is a perspective view of an atomization bracket according to a further embodiment of the present application;

FIG. 19 is a perspective view of the atomization bracket from a different angle according to a further embodiment of the present application;

FIG. 20 is a cross-sectional view of an atomizer in an inactivated state according to another embodiment of the present application;

FIG. 21 is a cross-sectional view of an atomizer in an activated state according to a further embodiment of the present application; and

FIG. 22 is an exploded view of the structure of an atomizer according to a further embodiment of the present application.

Reference numerals: 1, atomizer; 11, housing; 111, liquid storage chamber; 112, first mounting chamber; 113, guiding slot; 114, mouthpiece; 1141, aerosol outlet; 115, first engagement slot; 116, second engagement slot; 117, mounting protrusion; 118, first snap-fitting position; 12, atomization core assembly; 121, liquid inlet; 122, atomization tube; 1221, atomization tube base; 1222, mounting groove; 1223, support tube; 1224, second stopping portion; 1225, second snap-fitting position; 123, heating element; 124, atomization base; 1241, second mounting chamber; 1242, second snap-fitting position; 1243, atomizer air inlet; 125, inner wicking cotton; 126, liquid reservoir; 127, fixing structure; 128, atomization core body; 1281, electrode; 129, circuit board; 1291, first electrical contact; 13, core receptacle; 131, transition shell; 1311, mounting portion; 1312, piercing structure; 1313, first limiting portion; 1314, first positioning structure; 1315, second positioning structure; 1316, snap-fitting portion; 1317, first protrusion; 1318, second protrusion; 132, annular sealing member; 133, first snap-fitting portion; 134, first stopping portion; 14, driving member; 141, connecting portion; 1411, mounting groove; 1412, frangible structure; 142, driving portion; 15, housing base; 151, second limiting portion; 16, sealing top cover; 17, sealing plug; 18, liquid-absorbing member; 19, sealing member;
2, outer housing; 21, outer housing body; 22, fixed bracket; 221, third positioning structure; 222, fourth positioning structure; 23, first mounting port; 24, second mounting port; 241, cover cap;
3, power supply assembly; 31, power supply base; 311, locking structure; 312, air inlet hole; 32, battery cell; 33, power supply board; 34, power supply housing; 341, abutment protrusion;
41, inner liquid-conducting member; 42, outer liquid-conducting member; 43, atomization bracket; 431, first bracket segment; 4311, liquid-conducting hole; 432, second bracket segment; 433, liquid-filling port; 51, inner tube; 52, outer tube;
60, support member.

### DETAILED DESCRIPTION

The present disclosure will now be further described through specific embodiments with reference to the accompanying drawings. In different embodiments, similar components are labeled with related reference numerals. The following descriptions include numerous details to facilitate a clearer understanding of the present disclosure. However, those skilled in the art will readily recognize that some features may be omitted under specific circumstances or replaced by other components, materials, or methods. In certain instances, operations related to the invention are not explicitly illustrated or described in the specification. This omission is intentional to avoid obscuring the core aspects of the present disclosure with excessive detail. For brevity, it is unnecessary to exhaustively describe such operations, as a person skilled in the art can fully comprehend them based on the descriptions herein and general technical knowledge in the field.

Furthermore, the features, operations, or characteristics described in the specification may be combined in any suitable manner to form various embodiments. Similarly, the steps or actions in the method descriptions may be reordered or modified in ways that are obvious to those skilled in the art. The sequences outlined in the specification and drawings are provided solely to clearly describe specific embodiments and do not imply mandatory ordering unless explicitly stated otherwise.

Reference numerals assigned to components herein, such as “first,” “second,” and the like, are used solely to distinguish the described objects and imply no sequential or technical meaning. Additionally, the terms “connected” and “coupled,” as used herein, unless otherwise specified, include both direct and indirect connections or couplings.

In the present application, the terms “mounting/installation”, “arranged/disposed”, “provided with”, “connected”, “slidably connected”, and “fixed” should be construed broadly. For example, ‘connected’ and ‘coupled’ may be a fixed connection, a detachable connection, or an integrally formed structure; such connections may be mechanical or electrical in nature. Connections may be direct, indirectly established through an intermediary medium, or constitute internal communication between two devices, components, or constituent parts. Those skilled in the art may understand these terms in the context of the present application based on specific circumstances.

The present application provides an atomization device for heating an atomization matrix to generate an aerosol. The atomization device includes a power supply assembly and an atomizer. The power supply assembly is electrically connected to the atomizer to supply operating power and control the operation of the atomizer. The power supply assembly and the atomizer are detachably connected, thereby preventing leakage of the atomization matrix during transportation from damaging or corroding the power supply assembly. Connection methods between the power supply assembly and the atomizer include plug-in connection, threaded connection, or magnetic coupling.

The atomization matrix refers to any suitable compound or mixture of compounds that facilitates aerosol formation (e.g., thermally stable aerosols substantially resistant to degradation at the operating temperature of the system) during use. Suitable atomization matrices are well known in the art and include, but are not limited to: polyols, such as triethylene glycol, 1,3-butanediol, and glycerol; polyol esters, such as glycerol monoacetate, diacetate or triacetate; and aliphatic esters of mono-, di- or poly-carboxylic acids, such as dimethyl dodecanedioate and dimethyl tetradecanedioate. The atomization matrix is typically liquid, stored in a container or absorbed within porous structures such as storage cotton or porous ceramics.

The term “aerosol” as used herein refers to a dispersion system comprising solid or liquid particles suspended in a gaseous medium. In the context of this application, “aerosol” specifically denotes a substance that has undergone vaporization, atomization, spray formation, or jetting, thereby transitioning from a solid or liquid state into an inhalable form containing suspended particles of active constituents. Such aerosols may alternatively be termed vaporized matter.

The atomizer includes a housing, an atomization core assembly, and a transition shell. The housing defines a liquid storage chamber and a first mounting chamber therein. The liquid storage chamber is configured to store an atomization matrix. The atomization core assembly is disposed within the first mounting chamber and is configured to heat the atomization matrix to form an aerosol. At least a portion of the transition shell is disposed within the housing. At least a portion of the transition shell is sleeved around the atomization core assembly. The atomization device is operable between an activated state and an inactivated state. In the activated state, the liquid storage chamber is in fluid communication with the atomization core assembly. In the inactivated state, the liquid storage chamber is fluidly isolated from the atomization core assembly.

In some embodiments, the atomization core assembly comprises a liquid inlet (also referred to as an inlet hole, hereinafter the same). The transition shell is configured to occlude or expose the liquid inlet, wherein: in the activated state, the liquid storage chamber is in communication with the liquid inlet; in the inactivated state, the liquid storage chamber is isolated from the liquid inlet. The transition shell is moveable relative to the atomization core assembly, or vice versa, to isolate or connect the liquid storage chamber and the liquid inlet. This movement occludes or exposes the liquid inlet, such that: when exposed, the liquid storage chamber supplies the atomization matrix to the atomization core assembly through the liquid inlet, achieving liquid-core contact; and when occluded, the liquid storage chamber is isolated from the atomization core assembly, achieving liquid-core separation. This mechanism thereby prevents the atomization matrix from entering the atomization core assembly and avoids leakage via the atomization core assembly.

In other embodiments, the atomization core assembly includes an inner liquid-conducting member, an outer liquid-conducting member, and an atomization bracket. The outer liquid-conducting member is sleeved around the inner liquid-conducting member. The atomization bracket is axially divided into a first bracket segment and a second bracket segment. The first bracket segment is sleeved between the inner and outer liquid-conducting members. The second bracket segment has a liquid-filling port proximate to the first bracket segment, through which the inner and outer liquid-conducting members are in fluid communication. In the activated state, the liquid storage chamber is in communication with the outer liquid-conducting member. In the inactivated state, the liquid storage chamber is isolated from the outer liquid-conducting member. In these embodiments, the transition shell is moveable relative to the atomization core assembly, so that the liquid storage chamber is in communication with or isolated from the outer liquid-conducting member. Thus, through the contact of the outer liquid-conducting member and the inner liquid-conducting member, when the liquid storage chamber is in communication with the outer liquid-conducting member, the liquid storage chamber is in communication with the interior of the atomization core assembly. When the liquid storage chamber is isolated from the outer liquid-conducting member, the liquid storage chamber is isolated from the interior of the atomization core assembly.

The atomizer and atomization device of the present application will be described in detail below through specific embodiments.

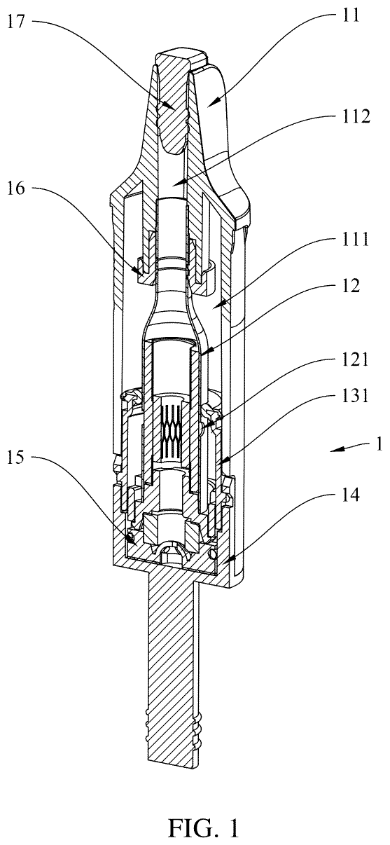

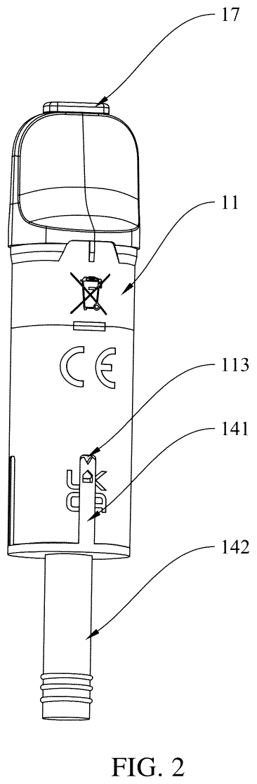

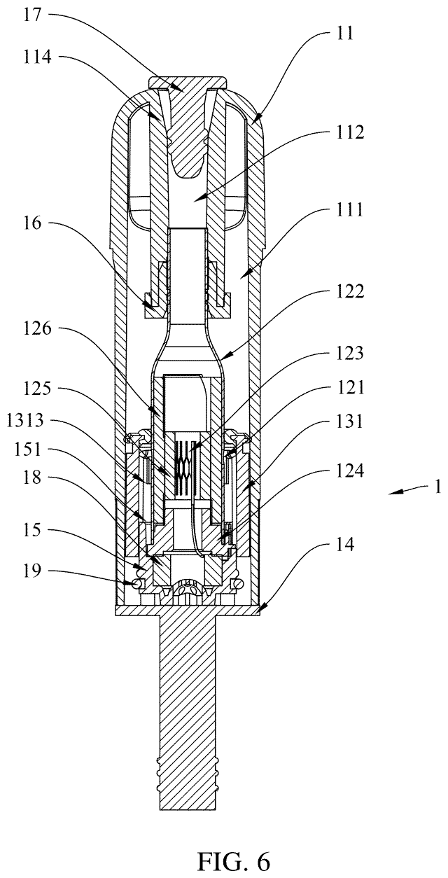

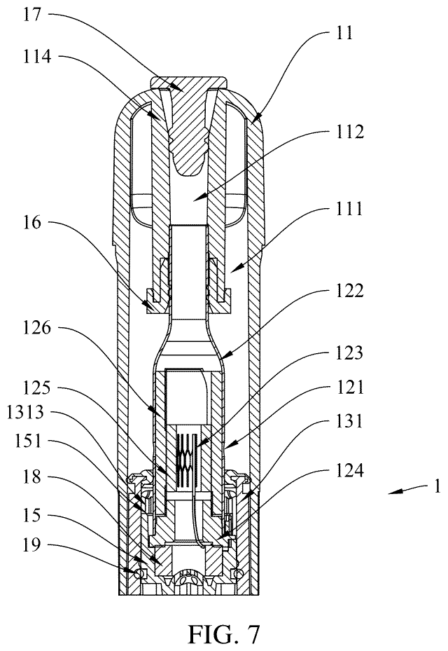

An embodiment of the present application may be understood with reference to FIGS. 1 to 7.

With reference to FIGS. 1 to 7, the atomizer 1 includes a housing 11, an atomization core assembly 12, a transition shell 131, and a driving member 14. In these embodiments, the transition shell 131 is movable relative to the atomization core assembly 12, and thus may be termed a movable component.

The housing 11 may be a multi-component with internally defined chambers for mounting different elements. For example, the housing 11 contains a liquid storage chamber 111 for storing an atomization matrix and a first mounting chamber 112 accommodating the atomization core assembly 12. The atomization core assembly 12 is configured to heat the atomization matrix to form an aerosol. The liquid storage chamber 111 and the first mounting chamber 112 may be coaxially arranged while remaining mutually isolated. Given the operational requirements of the atomizer 1, the first mounting chamber 112 is disposed within the liquid storage chamber 111, meaning the liquid storage chamber 111 concentrically surrounds both the first mounting chamber 112 and the atomization core assembly 12. As the liquid storage chamber 111 supplies the atomization matrix (heating target) to the atomization core assembly 12, a liquid passage structure typically provides fluid communication between them, including at least one liquid inlet 121 on the atomization core assembly 12. Multiple liquid inlets 121 may be uniformly distributed to ensure even inflow of the atomization matrix into the atomization core assembly 12, where “multiple” denotes two or more such inlets.

During operation of the atomization device, the first mounting chamber 112 communicates externally, potentially allowing leakage of the atomization matrix through the atomization core assembly 12 and the first mounting chamber 112, or through assembly gaps between the atomization core assembly 12 and the liquid storage chamber 111 or the housing 11. At least part of the transition shell 131 is disposed inside the housing 11 to seal the liquid storage chamber 111, with at least a portion movably sleeved around the atomization core assembly 12. Connected to the driving member 14, the transition shell 131 is driven to move relative to the atomization core assembly 12, enabling the transition shell 131 to occlude or expose the liquid inlet 121, thereby isolating or connecting the liquid storage chamber 111 and the atomization core assembly 12. During the transportation of the atomizer 1, the driving member 14 drives the transition shell 131 to occlude the liquid inlet 121, isolating the liquid storage chamber 111 from the atomization core assembly 12 (achieving liquid-core separation). This prevents the atomization matrix from entering the atomization core assembly 12 and avoids leakage through it. During use of the atomizer 1, the driving member 14 drives the transition shell 131 to expose the liquid inlet 121, activating the atomizer 1 to achieve liquid-core contact. The liquid storage chamber 111 continuously supplies the heating target (atomization matrix) to the atomization core assembly 12, ensuring normal operation of the atomizer 1 and thereby improving user experience.

By being disposed between the housing 11 and the atomization core assembly 12, the transition shell 131 seals the liquid storage chamber 111, seals the interface between the atomization core assembly 12 and the housing 11, and contains the atomization matrix within the liquid storage chamber 111. This configuration enhances the sealing integrity of the atomizer 1, thereby effectively preventing leakage of the atomization matrix through assembly gaps between components.

To increase the capacity of the atomizer 1 and enable its repeated use, a liquid-filling port that can be connected to the liquid storage chamber 111 can be arranged on the housing 11, and the atomization matrix can be replenished to the liquid storage chamber 111 through an external container.

In some embodiments, the transition shell 131 and the driving member 14 are detachably connected. After achieving liquid-core contact, the driving member 14 can be removed to facilitate installation of the power supply assembly. In this embodiment, the transition shell 131 is disposed at one end of the housing 11, enclosing both the transition shell 131 and the atomization core assembly 12, thereby further enhancing the sealing effectiveness. The transition shell 131 is made of silicone with superior sealing properties, possessing sufficient elasticity to seal all assembly clearances. Its low manufacturing cost and ease of processing allow the driving member 14 to function as a disposable consumable while maintaining relatively controllable costs. Further, the transition shell 131 is coaxially arranged with both the atomization core assembly 12 and the housing 11. During operation, it moves strictly along this central axis, preventing eccentric displacement (i.e., non-coaxial alignment between the transition shell 131 and the atomization core assembly 12/the housing 11) from compromising the sealing integrity.

Alternatively, in other embodiments, the transition shell 131 and the driving member 14 are fixedly connected and integrally formed as a single structure. Through this driving member 14, it is possible not only to switch the transition shell 131 from blocking the liquid inlet 121 to opening the liquid inlet 121, but also to perform the reverse operation to switch from opening the liquid inlet 121 to blocking the liquid inlet 121. This conveniently achieves mutual switching between liquid-core separation and liquid-core contact, effectively ensuring good sealing performance throughout the entire usage process of the atomizer 1 (including the process of stopping use after the first activation).

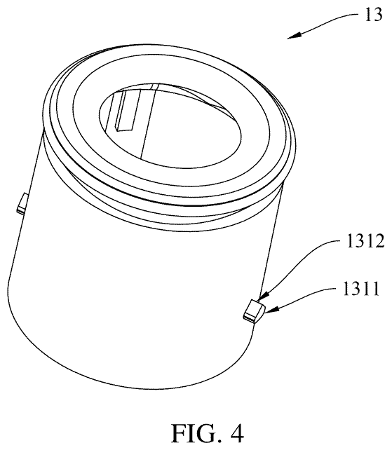

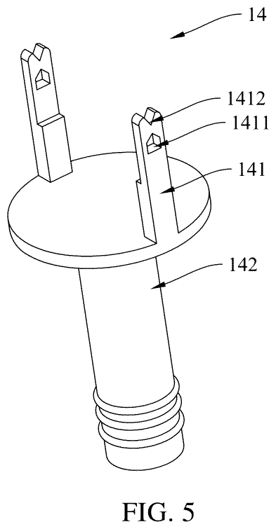

With reference to FIGS. 4 and 5, in some embodiments, the transition shell 131 is provided with a mounting portion 1311. The driving member 14 includes a connecting portion 141 and a driving portion 142, wherein the driving portion 142 is connected to the connecting portion 141. The end of the connecting portion 141 distal from the driving portion 142 is detachably connected to the mounting portion 1311. The connecting portion 141 and the driving portion 142 may be formed as an integral structure. Alternatively, the connecting portion 141 and the driving portion 142 may be separate components assembled into a unitary structure. Two such mounting portions 1311 are symmetrically disposed along the axis of the transition shell 131, with two corresponding connecting portions 141 provided accordingly. In other embodiments, the quantity of the mounting portion 1311 and the connecting portion 141 is not limited to two. The mounting portions 1311 are uniformly arranged along the circumference of the transition shell 131, with the connecting portions 141 corresponding to the mounting portions 1311. This configuration ensures uniform load distribution on the transition shell 131, preventing eccentric displacement caused by uneven forces that would compromise sealing integrity between the transition shell 131, the atomization core assembly 12, and the housing 11.

To effectively ensure the connection effectiveness between the connecting portion 141 and the mounting portion 1311, the connecting portion 141 is provided with a mounting groove 1411. The mounting portion 1311 is installed in the mounting groove 1411. The shape and dimensions of the mounting groove 1411 may correspond to those of the mounting portion 1311, facilitating positional constraint and secure fixation of the mounting portion 1311 through the mounting groove 1411. After the driving member 14 drives the transition shell 131 to the target position to achieve liquid-core contact, the presence of the mounting groove 1411 also enables convenient removal of the driving member 14.

To further facilitate detachable engagement between the driving member 14 and the transition shell 131, the connecting portion 141 has a frangible structure 1412. The structure is formed by: a recessed groove wall of the mounting groove 1411 facing away from the driving portion 142, and a concave depression at the end of the connecting portion 141 distal from the driving portion 142 extending toward the driving portion 142. A part of the mounting portion 1311 facing the frangible structure 1412 comprises a piercing structure 1312. Under an external force, the piercing structure 1312 ruptures the frangible structure 1412, enabling disengagement of the connecting portion 141 from the mounting portion 1311. Specifically, after the driving member 14 drives the transition shell 131 to the target position, the unique structural design of the frangible structure 1412 allows it to fracture readily upon sudden application of substantial force, thereby achieving removal of the driving member 14. In this embodiment, the piercing structure 1312 is configured as a cone or a polyhedral pyramid. Preferably, the piercing structure 1312 adopts a triangular pyramid configuration. The axial cross-section of the piercing structure 1312 along the axis of the housing 11 may be triangular. The frangible structure 1412 comprises two symmetrical triangular formations, resulting in reduced thickness at its central region (along the axial direction of the housing 11) to facilitate fracture.

The side wall of the housing 11 is provided with a guiding slot 113. The mounting portion 1311 is movably disposed within the guiding slot 113. The guiding slot 113 extends along the axial direction of the housing 11, and the driving member 14 is configured to drive the transition shell 131 to move along the axial direction of the housing 11. The arrangement of the guiding slot 113 guides movement of the transition shell 131, thereby ensuring smooth motion of the transition shell 131 and preventing the movement from compromising sealing integrity of the atomizer 1.

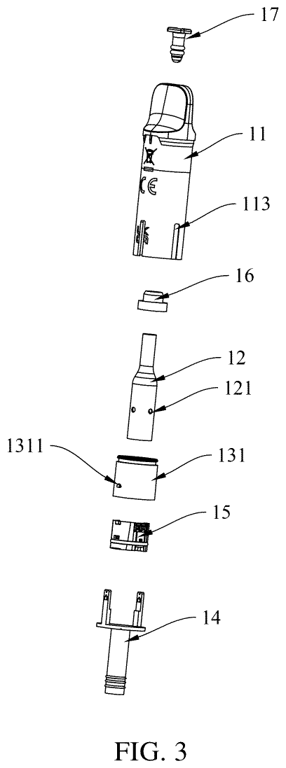

With reference to FIG. 3, in some embodiments, the guiding slot 113 penetrates through the side wall of the housing 11. The mounting portion 1311 extends externally from the housing 11 through the guiding slot 113, and the connecting portion 141 is clamped within the guiding slot 113 while being connected to the mounting portion 1311. Since the mounting portion 1311 protrudes externally from the housing 11 and the connecting portion 141 is disposed on the exterior of the housing 11, this configuration enables: the driving portion 142 and the connecting portion 141 to cooperatively seal the housing 11, achieving sealing effectiveness, and convenient removal and installation of the connecting portion 141. Alternatively, in other embodiments, the guiding slot 113 may be disposed on the inner wall of the housing 11, serving solely to guide movement of the transition shell 131.

To further enhance the sealing effectiveness, the atomizer 1 additionally includes a housing base 15. At least a portion of the housing base 15 is inserted in the housing 11 and disposed on a side of the atomization core assembly 12. The transition shell 131 is disposed between the housing 11 and the housing base 15. The housing base 15, the housing 11, the atomization core assembly 12, and the transition shell 131 cooperatively define a liquid storage chamber 111 with enhanced sealing integrity. To prevent the transition shell 131 from sliding out of the housing 11 and compromising the sealing, the transition shell 131 is provided with a first limiting portion 1313, while the housing base 15 is provided with a second limiting portion 151. When the transition shell 131 moves to open the liquid inlet 121, the first limiting portion 1313 and the second limiting portion 151 engage in abutment.

Since the transition shell 131 is sleeved externally about the atomization core assembly 12, movement of the transition shell 131 generates frictional forces between them. These forces may induce displacement of the atomization core assembly 12, potentially damaging the entire atomizer 1. To prevent this, the atomization core assembly 12 is interference-fitted with the first mounting chamber 112, ensuring a secure connection that prevents relative movement between the atomization core assembly 12 and the transition shell 131.

To enhance both the frictional force and sealing integrity between the atomization core assembly 12 and the first mounting chamber 112, the atomizer 1 further comprises a sealing top cover 16. The sealing top cover 16 is disposed between the atomization core assembly 12 and the first mounting chamber 112. Fabricated from silicone material, this sealing top cover 16 not only seals the gap between the first mounting chamber 112 and the atomization core assembly 12, but also utilizes the frictional force generated with the atomization core assembly 12 to secure it in position, thereby preventing displacement or detachment of the atomization core assembly 12.

The atomizer 1 further comprises a mouthpiece 114 formed on the housing 11 and in fluid communication with the first mounting chamber 112. The first mounting chamber 112 not only serves to mount and secure the atomization core assembly 12, but also establishes fluid communication between the mouthpiece 114 and the interior of the atomization core assembly 12. An interconnected airflow path is thus formed through the mouthpiece 114, the first mounting chamber 112 and the interior of the atomization core assembly 12, enabling aerosol to flow along this path to the mouthpiece 114. Since the mouthpiece 114 is in communication with the atomization core assembly 12, potential leakage of the atomization matrix through the mouthpiece 114 may occur. To address this, the atomizer 1 additionally includes a sealing plug 17 detachably disposed within the mouthpiece 114 to seal its opening. This detachable connection allows removal of the sealing plug 17 when activating the atomizer 1 for use. The transition shell 131 moves relative to the atomization core assembly 12 along the axial direction of the housing 11. When moving away from the mouthpiece 114, it switches from occluding the liquid inlet 121 to exposing it, thereby activating the atomizer 1 into a liquid-core contact state. In other embodiments, the transition shell 131 may also move in the opposite direction; that is, it moves closer to the mouthpiece 114 relative to the atomization core assembly 12 along the axis of the housing 11, thereby placing the atomizer 1 in a liquid-core separation state. This enables free switching between the liquid-core separation and liquid-core contact states of the atomizer 1.

Furthermore, the housing base 15 is disposed at the end of the housing 11 distal from the mouthpiece 114. A liquid-absorbing member 18 is provided between the housing base 15 and the atomization core assembly 12 for collecting the atomization matrix. At least a portion of the driving member 14 is sleeved externally about the housing base 15. To further enhance sealing effectiveness, a sealing member 19 is disposed on the exterior of the housing base 15. The sealing member 19 is configured as an O-ring. During the liquid-core contact operation, the sealing member 19 is disposed between the housing base 15 and the transition shell 131 to provide sealing functionality. The side of the O-ring is a smooth arc surface that reduces frictional forces and prevents interference with relative movement between the transition shell 131 and the housing base 15.

The atomization core assembly 12 includes an atomization tube 122, a heating element 123 (alternatively termed a heating component), an atomization base 124, an inner wicking cotton 125 and a liquid reservoir 126. At least a portion of the atomization tube 122 is disposed within the first mounting chamber 112 and in fluid communication with the mouthpiece 114. The liquid inlet 121 is formed on the sidewall of the atomization tube 122. The heating element 123 is disposed within the atomization tube 122. The atomization base 124 is mounted at the end of the atomization tube 122 distal from the mouthpiece 114, sealing this distal end. At least a portion of the transition shell 131 is movably sleeved about the exterior of the atomization tube 122. The liquid reservoir 126 is disposed on the inner wall surface of the atomization tube 122. The inner wicking cotton 125 is disposed on the side of the liquid reservoir 126 that faces away from the inner wall of the atomization tube 122. The heating element 123 is embedded onto the inner wicking cotton 125. During operation, the atomization matrix enters the liquid reservoir 126 via the liquid inlet 121, permeates through the inner wicking cotton 125, and is vaporized by the heating element 123. The heating element 123 may be configured as a mesh heating element, or alternatively as a heating tube or a heating wire.

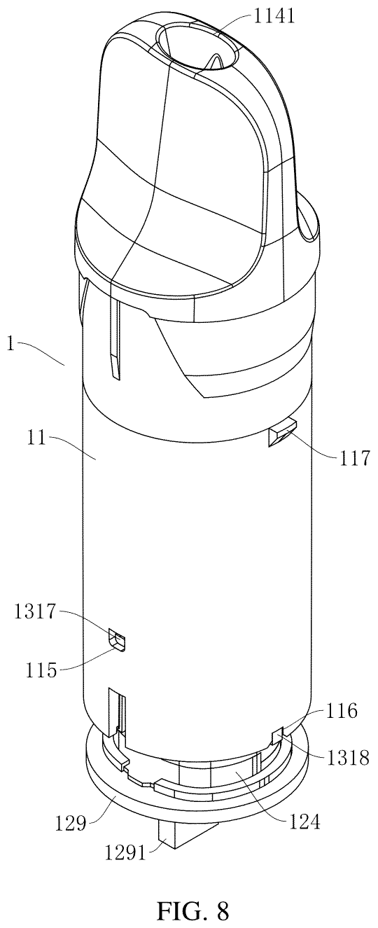

Another embodiment of the present application may be understood with reference to FIGS. 8 to 15.

In the embodiment of the present application, the coordinated configuration of the housing 11 (alternatively termed the liquid storage cup) and the atomization core assembly 12, combined with the engagement between the first positioning structure 1314 and the second positioning structure 1315 of the core receptacle 13 and the fixing structure 127 of the atomization core assembly 12, enables the atomization core assembly 12 to assume: a first mounted position where the liquid inlet 121 is fluidically isolated (alternative described as separated or sealed off) from the liquid storage chamber 111, and a second mounted position establishing fluid communication between the liquid inlet 121 and the liquid storage chamber 111. This configuration permits transportation of the atomizer with the atomization core assembly 12 secured in the first mounted position (inactivated state), maintaining isolation between the liquid inlet 121 and the liquid storage chamber 111 during transit. This effectively prevents ingress of the atomization matrix into the atomization tube 122 during shipping. For usage, transitioning the atomization core assembly 12 to the second mounted position (activated state) activates normal operation, thereby mitigating leakage risks during transportation of the atomizer 1.

As illustrated in FIGS. 8 to 11, an embodiment discloses an atomizer 1 comprising a housing 11 and an atomization core assembly 12. The housing 11 constitutes the primary structural component defining the external form of the atomizer 1, enabling user manipulation (holding/moving), assembly operations, and device operation. The atomization core assembly 12 serves as the core functional module of the atomizer 1, wherein the atomization matrix is heated to generate aerosol.

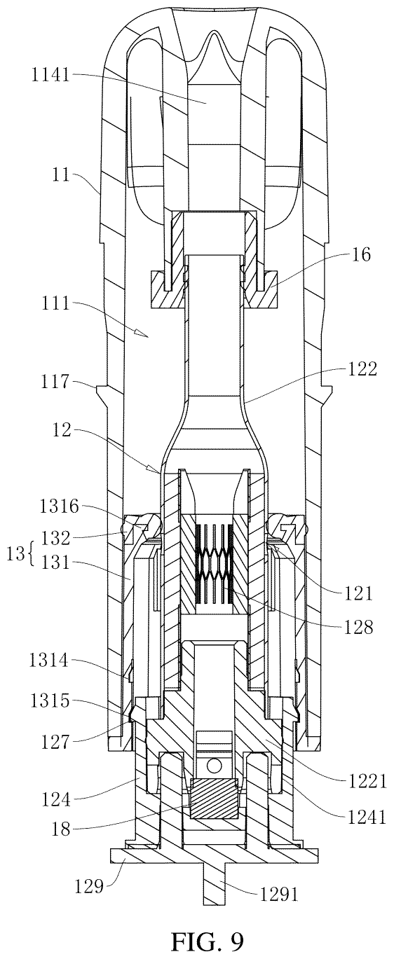

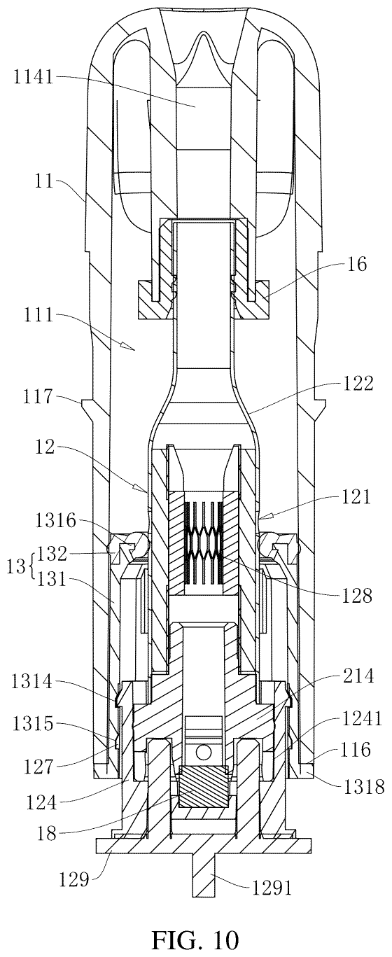

Regarding the housing 11, in an embodiment as shown in FIGS. 9 and 10, the housing 11 defines a first end and a second end along its axial direction. The first end has an aerosol outlet 1141, while the second end is provided with a core receptacle 13. The core receptacle 13 includes axially spaced first and second positioning structures 1314, 1315 configured to secure the atomization core assembly 12 at two discrete axial positions along the housing 11. This dual-position fixation mechanism accommodates distinct operational requirements including transportation and usage modes.

Illustrative referring to FIGS. 8 and 9, the housing 11 may comprise an integrally formed cup body section and an aerosol delivery section. The cup body section may be a cylindrical structure, while the aerosol delivery section may be a flattened structure. The aerosol outlet 1141 is disposed on the aerosol delivery section along the axial direction of the cup body section. The core receptacle 13 is disposed within the cup body section.

In various embodiments, the aerosol outlet 1141 may be integrally formed with the housing 11 or configured as a detachable component. For instance, a mouthpiece component (alternatively referred to as a mouthpiece element) may be independently disposed at the first end of the housing 11, with the aerosol outlet 1141 disposed on the mouthpiece component. Mounting the mouthpiece component onto the housing 11 incorporates the aerosol outlet 1141 into the housing 11.

Regarding the atomization core assembly 12, in an embodiment illustrated in FIGS. 8 and 9, the atomization core assembly 12 is axially movably engaged onto the core receptacle 13. The atomization core assembly 12, the core receptacle 13, and the housing 11 collectively enclose the liquid storage chamber 111. The atomization core assembly 12 includes an atomization tube 122 provided with a liquid inlet 121 that is in fluid communication with the liquid storage chamber 111. The atomization tube 122 establishes a sealed fluid path to the aerosol outlet 1141, while the atomization core assembly 12 heats the atomization matrix in the atomization tube 122 to produce aerosol. A fixing structure 127 on the atomization core assembly 12 engages with the first and second positioning structures 1314, 1315.

Illustratively referring to FIGS. 8 and 9, the atomization tube 122 is axially movably engaged with the core receptacle 13. The end of the atomization tube 122 proximate to the second end maintains sealed fluid communication with the aerosol outlet 1141 via the sealing top cover 16. Specifically, the end of the aerosol outlet 1141 proximate to the atomization tube 122 is fixedly provided with the sealing top cover 16 (e.g., a silicone sealing sleeve). The proximate end of the atomization tube 122 is inserted into this silicone sealing sleeve, maintaining dynamic sealed integrity during axial movement of the atomization tube 122. The atomization tube 122 may cooperate with the core receptacle 13 and the housing 11 to define a liquid storage chamber 111 for containing the atomization matrix. An atomization core body 128 is disposed within the atomization tube 122 and positioned to correspond with the liquid inlet 121. This configuration enables: absorption of the atomization matrix entering the atomization tube 122 through the liquid inlet 121, heating and vaporization by the heating element to generate aerosol, and discharge of aerosol through the aerosol outlet 1141. The atomization core body 128 may comprise layers sequentially arranged from the interior to the exterior: a heating element (alternatively termed a heating body), an inner wicking cotton, and a reservoir cotton (alternatively termed a liquid storage component). The liquid reservoir cotton abuts against the wall of the atomization tube 122, securing the atomization core body 128 in the atomization tube 122.

In other embodiments, the sealing top cover 16 and the atomization core body 128 may adopt different configurations, provided they satisfy design and operational requirements. The housing 11 may also be provided with a separate liquid storage chamber 111, which can be communicated with or isolated from the liquid inlet 121 as the liquid inlet 121 moves.

Referring to FIGS. 8 and 9, the first positioning structure 1314 and the second positioning structure 1315 define a first mounted position and a second mounted position relative to the housing 11 for the atomization core assembly 12. At the first mounted position, the fixing structure 127 engages with the first positioning structure 1314, while the core receptacle 13 blocks the liquid inlet 121. At the second mounted position, the fixing structure 127 engages with the second positioning structure 1315, with the liquid inlet 121 in fluid communication with the liquid storage chamber 111. The atomization core assembly 12 is switchable between the first mounted position and the second mounted position.

In this way, the atomizer 1 can be delivered from the factory, transported, and stored with the atomization core assembly 12 in the first mounted position (inactivated state). In this state, the liquid inlet 121 is sealed by the core receptacle 13 and isolated from the liquid storage chamber 111, preventing the atomization matrix stored in the liquid storage chamber 111 from entering the atomization tube 122 and minimizing the risk of leakage. When needed, the atomization core assembly 12 can be switched to the second mounted position (activated state), allowing the liquid inlet 121 to communicate with the liquid storage chamber 111. This enables the atomization matrix in the liquid storage chamber 111 to enter the atomization tube 122 through the liquid inlet 121, where it is heated to generate aerosol, thereby enabling convenient operation. The first positioning structure 1314 and the second positioning structure 1315 further assist in retaining the atomization core assembly 12 at the first mounted position and the second mounted position, respectively. This helps prevent unintended displacement of the atomization core assembly 12 due to external forces during transportation, use, or other scenarios, thereby reducing transportation damage and operational failures.

In an embodiment, as shown in FIGS. 8 and 9, the atomization core assembly 12 includes an atomization base 124, with the atomization tube 122 fixed thereto. The fixing structure 127 is a third protrusion arranged on the peripheral side of the atomization base 124. The end of the third protrusion adjacent to the liquid storage chamber 111 is provided with a wedge surface. The first positioning structure 1314 and the second positioning structure 1315 are positioning grooves configured to engage with the third protrusion. The provision of the atomization base 124 facilitates the overall fixation and positional adjustment of the atomization core assembly 12.

By way of example, please refer to FIGS. 8 and 9. The end of the atomization tube 122 distal from the aerosol outlet 1141 is provided with an atomization tube base 1221, which may be made of plastic, silicone, or other suitable materials. The atomization base 124 is provided with a second mounting chamber 1241 for accommodating the atomization tube base 1221. The atomization tube base 1221 is clamped within the second mounting chamber 1241, thereby fixing the atomization tube 122 to the atomization base 124.

In some embodiments, as shown in FIGS. 9 and 11, a liquid-absorbing member 18 may also be provided in the second mounting chamber 1241. The liquid-absorbing member 18 may be made of absorbent cotton or other porous materials to absorb condensate liquid generated within the atomization tube 122. In other embodiments, a gas supply hole may additionally be provided on the wall of the second mounting chamber 1241 to allow gas flow into the atomization tube 122.

In an embodiment, as shown in FIGS. 9 and 11, the atomization core assembly 12 may additionally include a circuit board 129 mounted to the end of the atomization core assembly 12 distal from the aerosol outlet 1141. The circuit board 129 is configured to receive a voltage and control the heating of the atomization matrix in the atomization tube 122 by the atomization core assembly 12. Integrating the circuit board 129 with the other components of the atomization core assembly 12 facilitates its adaptation to different types of atomization devices.

For example, the circuit board 129 is disposed on the side of the atomization base 124 opposite the atomization tube 122. The atomization base 124 may be provided with a wire routing hole to allow the wire connecting the circuit board 129 and the atomization core body 128 to pass through. The circuit board 129 can be configured to support the functionality of the atomizer 1, or an atomization device equipped with it, enabling all or part of its functions. These may include, but are not limited to, controlling the atomization core body 128 to heat the atomization matrix in the atomization tube 122, regulating the heating power of the atomization core body 128, and displaying status information of the atomizer 1 or the atomization device.

To ensure the core receptacle 13 effectively seals the liquid inlet 121 from the liquid storage chamber 111, in an embodiment as shown in FIGS. 8 and 9, the core receptacle 13 includes a transition shell 131 and an annular sealing member 132. The transition shell 131 is a cylindrical structure configured for fixed connection to the housing 11. The annular sealing member 132 is disposed at the end of the transition shell 131 adjacent to the liquid storage chamber 111. The annular sealing member 132 is made of elastic material and serves to isolate the liquid inlet 121 from the liquid storage chamber 111. The arrangement of the annular sealing member 132 utilizes its elasticity to reliably seal the liquid inlet 121 from the liquid storage chamber 111, thereby preventing leakage of the atomization matrix.

For example, referring to FIGS. 8 and 9, the transition shell 131 is a cylindrical structural component fixedly disposed in the housing 11. The end of the transition shell 131 proximate to the liquid storage chamber 111 is provided with an snap-fitting portion 1316 for fitting and securing the annular sealing member 132. The annular sealing member 132 is sleeved and clamped on the snap-fitting portion 1316. Furthermore, the radially-opposed sides of the annular sealing member 132 abut against the cup wall of the housing 11 and the tube wall of the atomization tube 122, respectively.

To prevent the atomization core assembly 12 from displacing the core receptacle 13 during the positional adjustment of the atomization core assembly 12, which could interfere with the adjustment process, in an embodiment as shown in FIGS. 8 and 11, the outer peripheral wall of the transition shell 131 is provided with a first protrusion 1317, and the wall of the housing 11 is provided with a first engagement slot 115 for receiving the first protrusion 1317. For example, the first protrusion 1317 may be disposed on the outer peripheral wall of the transition shell 131 at intervals along the circumferential direction, and the wall of the housing 11 is provided with a corresponding first engagement slot 115. The first engagement slot 115 may be arranged to correspond to the individual first protrusion 1317, or may be configured as a continuous annular groove. Either configuration can cooperate with the first protrusion 1317 to form an axial restraint for the transition shell 131. Additionally, the side of the first protrusion 1317 that is close to the first end may be configured as a wedge surface to facilitate the insertion of the transition shell 131 into the housing 11 from the second end.

In a further embodiment, as shown in FIGS. 8 and 11, the shape of the first engagement slot 115 is complementary to the shape of the first protrusion 1317. This configuration allows the cooperation between the first protrusion 1317 and the first engagement slot 115 to not only provide axial restraint to the transition shell 131 but also provide circumferential restraint, thereby enabling precise assembly.

In another embodiment, as shown in FIGS. 8 and 10, the end of the transition shell 131 distal from the aerosol outlet 1141 is provided with a second protrusion 1318. The second protrusion 1318 is configured to engage with the end face at the second end of the housing 11. The cooperation between the second protrusion 1318 and this end face provides axial restraint to the transition shell 131, preventing the core receptacle 13 from being pushed inward when the atomization core assembly 12 is inserted.

In a further embodiment, as shown in FIGS. 8 and 10, the end face of the second end of the housing 11 is provided with a second engagement slot 116 configured to receive the second protrusion 1318. The second engagement slot 116 restricts the movement of the second protrusion 1318, thereby providing circumferential restraint to the transition shell 131.

In yet another embodiment, as shown in FIGS. 8, 10 and 11, the transition shell 131 may be provided with both the aforementioned first protrusion 1317 and second protrusion 1318, while the housing 11 is correspondingly provided with the first engagement slot 115 and the second engagement slot 116. Their mutual cooperation provides enhanced restraint, thereby improving the overall positioning effect.

In other embodiments, other limiting structures may also be provided on the transition shell 131 and the annular sealing member 132 to provide restraint to the core receptacle 13.

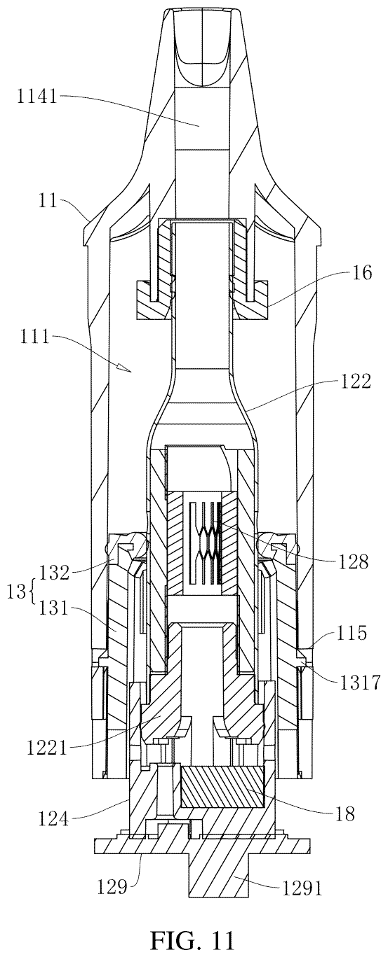

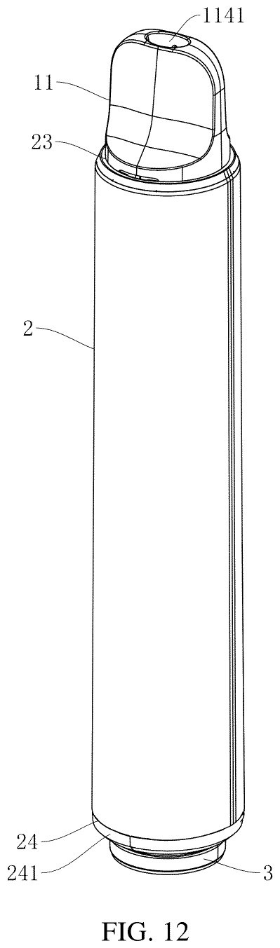

In an embodiment of an atomization device, as shown in FIGS. 12 to 15, the atomization device includes an outer housing 2, an atomizer 1, and a power supply assembly 3. At least portions of the atomizer 1 and the power supply assembly 3 are disposed in the outer housing 2. The atomizer 1 may be the atomizer 1 according to any of the embodiments described above. The power supply assembly 3 is electrically connectable to the atomization core assembly 12. The atomization device equipped with the atomizer 1 of the aforementioned embodiments effectively prevents leakage of the atomization matrix during transportation, thereby helping to reduce transportation losses.

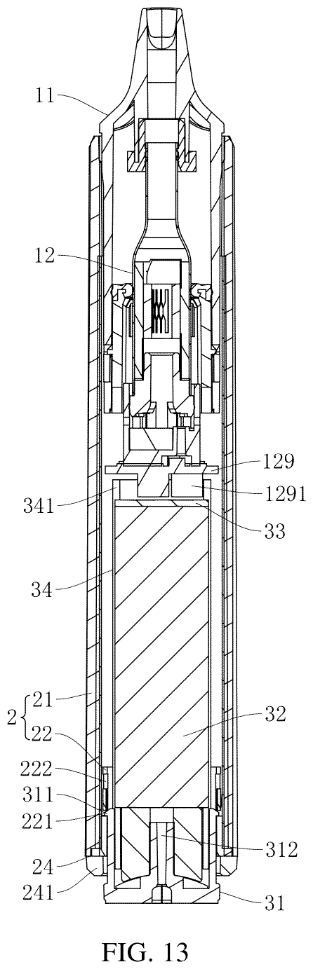

In an embodiment, as shown in FIGS. 13 to 15, the atomizer 1 is disposed at one axial side of the outer housing 2, while the power supply assembly 3 is movably arranged at the opposite axial side. The atomization core assembly 12 is positioned on the side of the atomizer 1 adjacent to the power supply assembly 3. The power supply assembly 3 is configured to move relative to the outer housing 2 between a transitional position and a working position. During its movement from the transitional position to the working position, the power supply assembly 3 abuts against and pushes the atomization core assembly 12, thereby causing it to move from the first mounted position to the second mounted position. Accordingly, the atomization device can be transported with the power supply assembly 3 in the transitional position and the atomization core assembly 12 in the first mounted position. During use, moving the power supply assembly 3 to its working position simultaneously drives the atomization core assembly 12 to its second mounted position. This integrated actuation eliminates the need for an additional adjustment mechanism within the outer housing 2 for positioning the atomization core assembly 12, thereby simplifying the overall structure of the atomization device.

It should be specifically emphasized that the transitional position of the power supply assembly 3 may be defined as any position from which it can push the atomization core assembly 12 toward the second mounted position. For example, this position may be one where it is in contact with the atomization core assembly 12 at the first mounted position, or a position where it is spaced apart from the atomization core assembly 12 at the first mounted position.

In an embodiment, as shown in FIGS. 13 to 15, the side of the outer housing 2 configured to receive the power supply assembly 3 is provided with a third positioning structure 221 and a fourth positioning structure 222. These structures are axially spaced along the outer housing 2. The power supply assembly 3 includes a locking structure 311 configured to engage with both the third positioning structure 221 and the fourth positioning structure 222. When the power supply assembly 3 is in the transitional position, the locking structure 311 engages with the third positioning structure 221, thereby securing the power supply assembly 3 in a position spaced apart from the atomization core assembly 12. When the power supply assembly 3 is in the working position, the locking structure 311 engages with the fourth positioning structure 222, thereby securing the power supply assembly 3 in a position where the atomization core assembly 12 is in contact with the second mounted position. The provision of the third positioning structure 221 and the fourth positioning structure 222 ensures the power supply assembly 3 has a defined transitional position, preventing accidental displacement or detachment during transportation or use, which improves operational and transport safety.

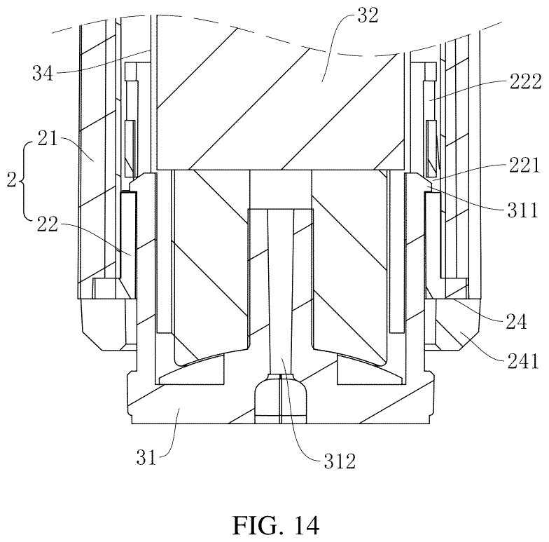

By way of example, referring to FIGS. 13 and 14, the outer housing 2 includes a housing body 21 and a fixed bracket 22 disposed at one axial end of the housing body 21. The fixed bracket 22 is provided with a third positioning structure 221 and a fourth positioning structure 222, which are spaced apart along the axial direction of the outer housing 2. The power supply assembly 3 includes a power supply base 31 and a battery cell 32 mounted on the power supply base 31. The power supply base 31 is slidably engaged with the fixed bracket 22 along the axial direction of the outer housing 2. A locking structure 311 is disposed on the peripheral side of the power supply base 31. In some implementations, the third positioning structure 221 and the fourth positioning structure 222 may be configured as limit slots, and the locking structure 311 may be a corresponding limiting protrusion. A wedge surface may also be provided on the side of the limiting protrusion close to the atomizer to facilitate switching the power supply assembly 3 from the transitional position to the working position.

In some embodiments, the housing body 21 may further include an outer housing and an inner shell, with the outer housing sleeved around the inner shell. A label may be sandwiched between the outer housing and the inner shell. An air inlet hole 312 may also be provided on the power supply base 31.

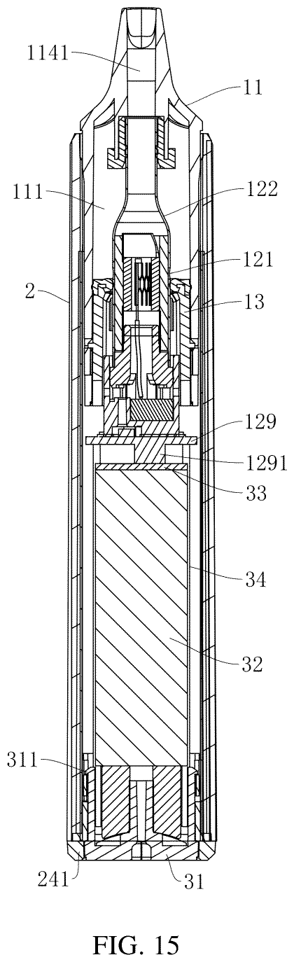

In one embodiment, as shown in FIGS. 13 and 15, the atomization core assembly 12 includes a circuit board 129 disposed at the end of the atomization core assembly 12 distal from the aerosol outlet 1141. The circuit board 129 is configured to receive voltage to control the atomization core assembly 12 to heat the atomization matrix in the atomization tube 122. A first electrical contact 1291 is provided on the side of the circuit board 129 distal from the aerosol outlet 1141. The power supply assembly 3 includes a power supply board 33 disposed on the side of the power supply assembly 3 close to the atomizer. The power supply board 33 is provided with a second electrical contact (not shown in the figures). When the power supply assembly 3 is in the working position, the second electrical contact engages with the first electrical contact 1291 to establish electrical conduction. When the power supply assembly 3 is in the transitional position, the power supply assembly 3 is electrically disconnected from the atomizer 1, ceasing power delivery to the atomizer 1. This configuration prevents safety-critical failures such as short-circuits in the power supply assembly 3 during leakage events, ensuring reliable device startup.

By way of example, as shown in FIGS. 13 and 15, the power supply board 33 is electrically connected to the battery cell 32. The second electrical contact includes a positive contact tab and a negative contact tab disposed on the power supply board 33. The first electrical contact 1291 includes a positive contact stud and a negative contact stud mounted on the circuit board 129. The positive contact stud is paired with the positive contact tab, and the negative contact stud is paired with the negative contact tab. When the power supply assembly 3 moves to the working position, the positive contact stud and the positive contact tab are brought into contact to establish electrical conduction, while the negative contact stud and the negative contact tab simultaneously establish electrical conduction through contact. In other embodiments, the first electrical contact 1291 and the second electrical contact may utilize other electrical contact components capable of achieving conductive engagement.

In one embodiment, as shown in FIGS. 13 and 15, the power supply assembly 3 includes a power supply housing 34. The end of the power supply housing 34 adjacent to the circuit board 129 is provided with an abutment protrusion 341 configured to exert a pushing force on the circuit board 129. This abutment mechanism reduces mechanical load on the first electrical contact 1291 and the second electrical contact, thereby preserving their electrical conductivity. By way of example, the power supply housing 34 is assembled to the power supply base 31, with the battery cell 32 and the power supply board 33 secured in the internal cavity of the power supply housing 34. The abutment protrusion 341 may be configured as a convex ring, or two or more discrete protrusions circumferentially spaced about the power supply housing 34. This configuration ensures uniformly distributed force application to the circuit board 129, preventing binding during actuation of the power supply assembly 3.

In one embodiment, as shown in FIGS. 12 and 13, the outer housing 2 has a first mounting port 23 and a second mounting port 24 at its respective axial ends. The first mounting port 23 is configured for mounting the atomizer, while the second mounting port 24 is configured for mounting the power supply assembly 3. By mounting the atomizer and the power supply assembly 3 from opposite ends of the outer housing 2, this arrangement prevents accidental actuation of the atomization core assembly 12 to the second mounted position or premature engagement of the power supply assembly 3 to its working position during the assembly. Consequently, this design simplifies the assembly requirements.

In some embodiments, the wall of the housing 11 may also be provided with an engagement structure. The engagement structure may be a mounting protrusion 117 (as shown in FIG. 8), with the wall of the outer housing 2 provided with a mating retention slot for snap-engagement with the mounting protrusion 117. Cooperative engagement between the mounting protrusion 117 and the retention slot secures the atomizer to the outer housing 2. The side of the mounting protrusion 117 distal from the aerosol outlet 1141 may be provided with a wedge surface to facilitate insertion of the atomizer 1 through the first mounting port 23.

In some embodiments, referring to FIGS. 13 and 14, the outer housing 2 may be provided with a cover cap 241 at the rim of the second mounting port 24. When the power supply assembly 3 is in the transitional position, the power supply base 31 protrudes partially beyond the cover cap 241. When the power supply assembly 3 is in the working position, the power supply base 31 is flush with the cover cap 241, providing visual confirmation to a user that the power supply assembly 3 has engaged the working position.

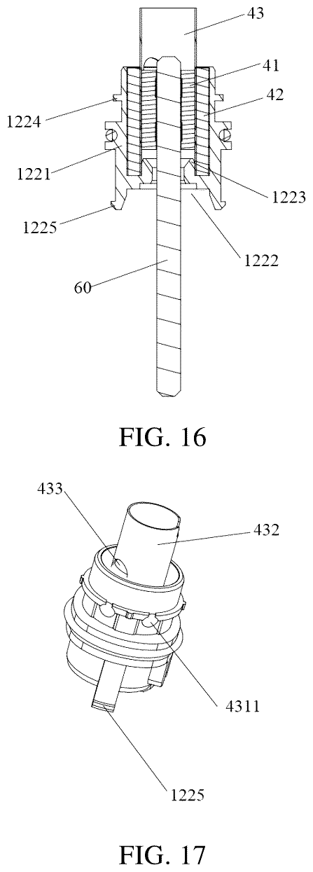

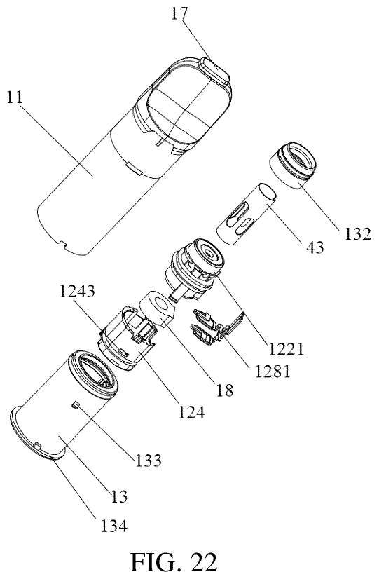

For yet another embodiment of the present application, refer to FIGS. 16 to 22.

In an embodiment of the present application, an atomization core assembly 12 is provided for use in the atomizer 1 and the atomization device. The atomization core assembly 12 is configured to heat and atomize stored atomization matrix in the atomization device. Upon atomization, the atomization matrix transitions into an inhalable state, specifically forming aerosol for user inhalation.

Referring to FIGS. 16 to 22, the atomization core assembly 12 includes: an inner liquid-conducting member 41, an outer liquid-conducting member 42, and an atomization bracket 43.

The outer liquid-conducting member 42 is sleeved over the outer side of the inner liquid-conducting member 41.

The atomization bracket 43 is divided into a first bracket segment 431 and a second bracket segment 432 along the axial direction. The first bracket segment 431 is sleeved between the inner liquid-conducting member 41 and the outer liquid-conducting member 42. The second bracket segment 432 has a liquid-filling port 433 on the side adjacent to the first bracket segment 431, establishing fluid communication between the inner liquid-conducting member 41 and the outer liquid-conducting member 42 through the liquid-filling port 433.

In the atomization core assembly 12 of the foregoing embodiments, pre-filling may be performed by injecting the matrix to be atomized into either the inner liquid-conducting member 41 or the outer liquid-conducting member 42. The liquid-filling port 433 then facilitates the distribution of the injected matrix to be atomized across both the inner liquid-conducting member 41 and the outer liquid-conducting member 42, enabling simultaneous pre-filling of both the inner liquid-conducting member 41 and the outer liquid-conducting member 42. This dual-distribution mechanism enhances operational reliability of the atomization core assembly 12 and consequently optimizes performance of the atomizer 1 incorporating the atomization core assembly 12.

When pre-filling the atomization core assembly 12 of the present application (e.g., using an injection needle), the matrix to be atomized may be injected into either the inner liquid-conducting member 41 or the outer liquid-conducting member 42. It should be noted that the injection needle is preferably positioned above the target liquid-conducting member. For example, when injecting the inner liquid-conducting member 41 as shown in FIG. 16, the injection needle is placed above the inner liquid-conducting member 41, where the matrix to be atomized drips onto the inner liquid-conducting member 41. Excess matrix to be atomized on the inner liquid-conducting member 41 overflows through the liquid-filling port 433 to the top surface of the outer liquid-conducting member 42, and the overflow matrix is absorbed by the outer liquid-conducting member 42, thereby achieving the pre-filling of both the inner liquid-conducting member 41 and the outer liquid-conducting member 42.

Referring to FIGS. 16 to 21, both the inner liquid-conducting member 41 and the outer liquid-conducting member 42 are configured as annular cylinders, while the atomization bracket 43 is tubular. The atomization core assembly 12 further includes a heating element 123 (also referred to as a heating member or heating plate) fixed to the inner wall of the inner liquid-conducting member 41. The heating element 123 is configured to heat the atomization matrix deposited on the inner wall of the inner liquid-conducting member 41. The heating element 123 may include resistive structures including but not limited to mesh, foil, or wire configurations.

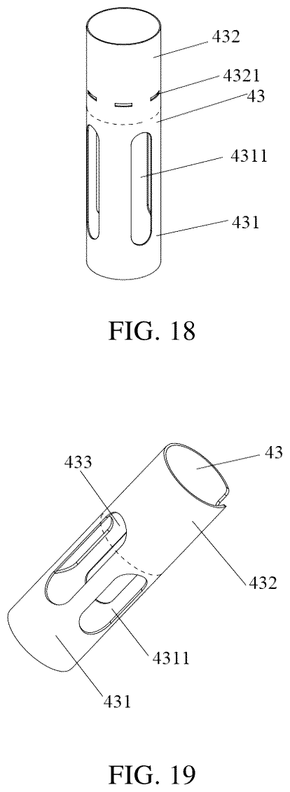

Referring to FIGS. 18 and 19, the liquid-filling ports 433 are configured as in a plurality (e.g., 2, 3, or 4 ports) arranged circumferentially about the axis of the atomization bracket 43. During pre-filling operations, such as when injecting the matrix to be atomized into the inner liquid-conducting member 41, the equidistant circumferential distribution of multiple ports enables simultaneous overflow of excess matrix through all ports onto the outer liquid-conducting member 42. This parallel overflow mechanism delivers uniform matrix distribution across the outer member 42, ensuring consistent pre-filling saturation.

Referring to FIGS. 18 and 19, the dotted lines in the figures indicate the boundary between the first and second bracket segments 431, 432 of the atomization bracket 43. Certain liquid-filling ports 433 extend to the first bracket segment 431 to connect the inner liquid-conducting member 41 and the outer liquid-conducting member 42 on both sides of the first bracket segment 431. The end of the inner liquid-conducting member 41 facing the second bracket segment 432 is recessed toward the first bracket segment 431 relative to the corresponding end of the outer liquid-conducting member 42 facing the second bracket segment 432.

In the atomization core assembly 12, both the outer liquid-conducting member 42 and the inner liquid-conducting member 41 are configured to absorb and transport the matrix to be atomized. Given this function, both the outer liquid-conducting member 42 and the inner liquid-conducting member 41 may comprise porous materials, such as wicking cotton. When the atomization core assembly 12 is working, the matrix to be atomized stored in the atomization device is first transferred to the outer liquid-conducting member 42. Subsequently, the outer liquid-conducting member 42 absorbs and transfers the matrix to be atomized to the inner liquid-conducting member 41; thereafter, the inner liquid-conducting member 41 conducts the matrix to its inner wall for atomization by the heating element 123. In practical implementations of the atomization core assembly 12, the outer liquid-conducting member 42 has a relatively smaller thickness than the inner liquid-conducting member 41. Therefore, to facilitate the liquid injection process, a liquid injection structure (such as an injection needle) is first used to deliver matrix to be atomized to the inner liquid-conducting member 41. The matrix to be atomized then overflows through the liquid-filling ports 433 at the top surface of the inner liquid-conducting member 41 to the outer liquid-conducting member 42, thereby achieving liquid injection into the outer liquid-conducting member 42.

Some liquid-filling ports 433 extend to the first bracket segment 431, thereby establishing fluid communication between the inner liquid-conducting member 41 and the outer liquid-conducting member 42 on both sides of the first bracket segment 431. This design serves dual purposes: during liquid injection, it allows the matrix to be atomized on the inner liquid-conducting member 41 to be directed to the outer liquid-conducting member 42 through the liquid-filling ports 433 in the second bracket segment 432, while also enabling the pre-filling matrix to be atomized inside the inner liquid-conducting member 41 to be transferred to the outer liquid-conducting member 42 via the liquid-filling ports 433 in the first bracket segment 431. This improves the pre-filling efficiency for both the inner liquid-conducting member 41 and the outer liquid-conducting member 42. Moreover, during operation of the atomization core assembly 12, it facilitates the transfer of the stored matrix to be atomized from the outer liquid-conducting member 42 to the inner liquid-conducting member 41.

Referring to FIG. 16, the end of the inner liquid-conducting member 41 facing the second bracket segment 432 is recessed toward the first bracket segment 431 relative to the end of the outer liquid-conducting member 42 facing the second bracket segment 432, meaning the top surface of the outer liquid-conducting member 42 is higher than that of the inner liquid-conducting member 41. This configuration ensures effective liquid injection into the inner liquid-conducting member 41 during pre-filling: after a sufficient amount of matrix to be atomized is injected into the inner liquid-conducting member 41, any excess on its top surface overflows through the liquid-filling ports 433 to the outer liquid-conducting member 42. In other embodiments, the height of the top surface of the outer liquid-conducting member 42 and that of the inner liquid-conducting member 41 may be the same or equal.

Specifically, referring to FIG. 19, in the embodiment of the present application, the liquid-filling port 433 is configured as an elongated hole, and the length direction of the slot is parallel to or inclined relative to the axial direction of the atomization bracket 43.

Preferably, during pre-filling of the inner liquid-conducting member 41 and the outer liquid-conducting member 42, the injection volume should not exceed half of the total volume of both the inner and outer liquid-conducting members 41 and 42.

As shown in FIGS. 18-19, the first bracket segment 431 is provided with a liquid-conducting hole 4311, through which the inner liquid-conducting member 41 and the outer liquid-conducting member 42 on both sides of the first bracket segment 431 communicate. The number of liquid-conducting holes 4311 may be configured as one or more as required—for example, two such holes may be provided. In this configuration, the inner and outer liquid-conducting members 41, 42 on both sides of the first bracket segment 431 are interconnected not only via the liquid-filling port 433 but also through the liquid-conducting hole 4311. Regions of the first bracket segment 431 without the liquid-filling port 433 and the liquid-conducting hole 4311 serve to separate the outer liquid-conducting member 42 and the inner liquid-conducting member 41, thereby preventing an excessively large flow path between the outer liquid-conducting member 42 and the inner liquid-conducting member 41 during operation of the atomization core assembly 12. This design avoids the transfer of an excessive amount of matrix to be atomized from the outer liquid-conducting member 42 to the inner liquid-conducting member 41, which could lead to leakage in the inner liquid-conducting member 41.

Referring to FIG. 18, in other embodiments, the liquid-filling port 433 is configured as an elongated hole whose length extends along the circumferential direction of the atomization bracket 43. In such cases, the elongated hole is only provided on the side of the second bracket segment 432 adjacent to the first bracket segment 431. The end of the elongated hole near the inner liquid-conducting member 41 may be flush with the top surface of the inner liquid-conducting member 41, or it may be higher than the top surface of the inner liquid-conducting member 41. The top surface of the outer liquid-conducting member 42 may be higher than, lower than, or flush with the top surface of the inner liquid-conducting member 41. Preferably, the end of the elongated hole near the inner liquid-conducting member 41 is higher than both the top surface of the inner liquid-conducting member 41 and the top surface of the outer liquid-conducting member 42. Compared with round or square holes, the elongated hole is narrower, which helps control the amount of liquid overflowing from the inner liquid-conducting member 41 to the outer liquid-conducting member 42. This prevents excessive liquid from transferring from the inner liquid-conducting member 41 to the outer liquid-conducting member 42 at once, which could exceed the absorption capacity of the outer liquid-conducting member 42 and cause the matrix to be atomized to accumulate in unintended regions. Meanwhile, the elongated hole can be designed with a relatively long length to facilitate liquid injection over a larger circumferential portion of the outer liquid-conducting member 42, thereby improving liquid injection efficiency. It should be understood that the liquid-filling ports 433 on the second bracket segment 432 are provided in multiple numbers to enable simultaneous liquid injection at different circumferential positions of the outer liquid-conducting member 42.

Referring to FIG. 16, in other embodiments, the atomization core assembly 12 further includes a support member 60. During assembly of the atomization core assembly 12 or pre-filling, the support member 60 is inserted into the inner liquid-conducting member 41 and contacts the inner wall of the inner liquid-conducting member 41. The support member 60 may be specifically configured as columnar or tubular. When the support member 60 is tubular, the bottom of the support member 60 is disposed on the side facing the second bracket segment 432. The use of the support member 60 during assembly of the atomization core assembly 12 helps preserve the structural integrity of the inner liquid-conducting member 41, the outer liquid-conducting member 42, and the heating element 123, thereby preventing deformation. During pre-filling, the top end of the support member 60 may extend above the top surface of the inner liquid-conducting member 41—for example, the top end of the support member 60 is 1 mm higher than the top surface of the inner liquid-conducting member 41—to prevent leakage during liquid injection into the inner liquid-conducting member 41. Once pre-filling is completed or the atomization core assembly 12 is fully assembled, the support member 60 is removed.

Refer to FIGS. 16 to 22, another embodiment of the present application provides an atomizer 1, including: an atomization core assembly 12, a housing 11, and an transition shell 131. The atomization core assembly 12 is the atomization core assembly 12 described in the preceding embodiments. The housing 11 has a liquid storage chamber 111 for storing the matrix to be atomized. One end of the housing 11 is provided with a mouthpiece 114, and the other end is provided with a second mounting port 24. The transition shell 131 is fitted into the housing 11 through the second mounting port 24, and the atomization core assembly 12 is disposed inside the transition shell 131, with the second bracket segment 432 located on the side facing the mouthpiece 114. The atomizer 1 has an activated state and a inactivated state. In the activated state, the liquid storage chamber 111 is in communication with the outer liquid-conducting member 42; in the inactivated state, the liquid storage chamber 111 is isolated from the outer liquid-conducting member 42. The side wall of the housing 11 is provided with two first snap-fitting positions 118 spaced axially apart. The outer side wall of the transition shell 131 has a first snap-fitting portion 133 configured to engage with the first snap-fitting positions 118 at different axial locations to switch the atomization device between its different states. A plurality of first snap-fitting positions 118 (for example, two) may be provided at the same axial location on the housing 11. Correspondingly, a plurality of first snap-fitting portions 133 (for example, two) are provided on the outer side wall of the transition shell 131 at the same axial position. The multiple first snap-fitting positions 118 and the multiple first snap-fitting portions 133 are arranged in corresponding pairs, thereby ensuring the connection strength or stability between the housing 11 and the transition shell 131.

The designed atomizer 1 ensures improved performance through its activated and inactivated states. For example, when the atomizer 1 is not used for an extended period, it can be set to the inactivated state via the engagement between the housing 11 and the transition shell 131. This prevents contact between the matrix to be atomized and the outer liquid-conducting member 42, thereby avoiding unnecessary waste due to evaporation or vaporization, and better preserving the flavor of the matrix to be atomized. When using the atomizer 1, it can be switched to the activated state by engaging the first snap-fitting portion 133 with the corresponding first snap-fitting position 118. Furthermore, since the atomization core assembly 12 is pre-filled with liquid in the atomizer 1, a user can start using the atomizer 1 immediately without waiting for the matrix to be atomized to be transferred to the inner liquid-conducting member 41, making the atomizer 1 more convenient to use.

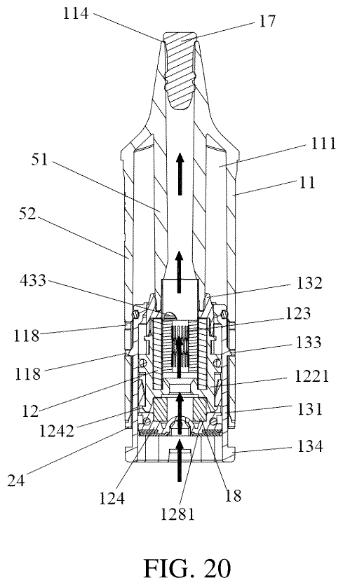

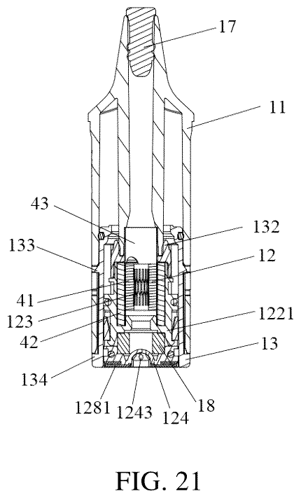

Refer to FIGS. 20 to 22, the end of the transition shell 131 away from the mouthpiece 114 is provided with a first stopping portion 134 configured to abut against the second mounting port 24. The first stopping portion 134 may, for example, be a block or ring protruding radially from the outer wall of the transition shell 131. The abutment between the first stopping portion 134 and the second mounting port 24 helps restrict the relative position between the housing 11 and the transition shell 131, thereby preventing over-operation. As shown in FIG. 20, the atomizer 1 is in the inactivated state at this point, with the first snap-fitting portion 133 engaged with the lower first snap-fitting position 118 on the housing 11. When the atomizer 1 needs to be switched to the activated state, pushing the transition shell 131 upward causes the first snap-fitting portion 133 to engage with the upper first snap-fitting position 118 on the housing 11, resulting in the structure shown in FIG. 21. At this point, the first stopping portion 134 comes into contact with the second mounting port 24, and no further pushing of the transition shell 131 is required.

Referring to FIGS. 20 to 22, the atomizer 1 further includes an atomization tube base 1221 and an annular sealing member 132. The housing 11 includes an inner tube 51 and an outer tube 52, wherein the liquid storage chamber 111 is formed between the inner tube 51 and the outer tube 52. The atomization tube base 1221 is fixed in the transition shell 131, and the side wall of the atomization tube base 1221 is provided with a liquid inlet 121. In the activated state, the top of the transition shell 131 and the annular sealing member 132 are spaced apart, allowing the liquid storage chamber 111 to communicate with the outer liquid-conducting member 42 via the liquid inlet 121. In the inactivated state, the inner diameter of the top of the transition shell 131 forms an interference fit with the outer wall of the annular sealing member 132, thereby isolating the liquid storage chamber 111 from the liquid inlet 121. The atomization core assembly 12 is fixed in the atomization tube base 1221, with a portion of the second bracket segment 432 sleeved in the inner tube 51. One end of the annular sealing member 132 is fitted over the inner tube 51, and the other end is fitted over the atomization tube base 1221.

To ensure the sealing performance of the atomizer 1, a sealing ring is provided between the transition shell 131 and the outer tube 52 of the housing 11. The sealing ring is always positioned between the first snap-fitting position 118 and the mouthpiece 114. Additionally, a sealing ring is provided between the atomization tube base 1221 and the transition shell 131. The atomization tube base 1221 forms an interference fit with the inner wall of the transition shell 131 via this sealing ring. The liquid inlet 121 is located on the side of the sealing ring (which is positioned between the atomization tube base 1221 and the transition shell 131) that faces the mouthpiece 114.

Referring to FIGS. 16, 20-22, the atomizer 1 further includes a liquid-absorbing member 18. The end of the atomization tube base 1221 away from the atomization core assembly 12 is provided with a mounting groove 1222, in which the liquid-absorbing member 18 is disposed. The liquid-absorbing member 18 is in communication with the inner liquid-conducting member 41 and serves to absorb any leaked matrix to be atomized from the inner liquid-conducting member 41. The liquid-absorbing member 18 is also annular and cylindrical in shape, with an inner diameter smaller than that of the inner liquid-conducting member 41. This design facilitates the absorption of the matrix to be atomized that leaks from the inner liquid-conducting member 41. For example, the liquid-absorbing member 18 may be made of absorbent cotton.

Referring to FIG. 16, correspondingly, the atomization tube base 1221 is provided with corresponding holes to establish communication between the inner liquid-conducting member 41 and the liquid-absorbing member 18. The side of the atomization tube base 1221 facing the atomization core assembly 12 is provided with a mounting chamber. A support tube 1223 is disposed in the mounting chamber at a position corresponding to the holes on the atomization tube base 1221. The outer diameter of the outer liquid-conducting member 42 is adapted to the radial dimension of the mounting chamber. Meanwhile, the outer liquid-conducting member 42 is sleeved over the support tube 1223—for example, it may be fitted around the outer side of the support tube 1223. The inner liquid-conducting member 41 either abuts against or is axially spaced apart from the support tube 1223. A second stopping portion 1224 is provided on the outer wall of the atomization tube base 1221 and abuts against the annular sealing member 132, thereby providing a positional limit for the annular sealing member 132.

Referring to FIGS. 17, 20-22, the atomization device further includes an atomization base 124, which is connected to the atomization tube base 1221. The liquid-absorbing member 18 is secured between the atomization base 124 and the atomization tube base 1221. The side of the atomization base 124 facing the atomization tube base 1221 is provided with a hollow chamber, and a portion of the atomization tube base 1221 is received in the hollow chamber. The liquid-absorbing member 18 may be entirely accommodated in the mounting groove 1222 and abut against the atomization tube base 1221. Alternatively, a portion of the liquid-absorbing member 18 may be placed in the mounting groove 1222, with the remainder situated in the hollow chamber. In this configuration, the liquid-absorbing member 18 is clamped and fixed between the atomization base 124 and the atomization tube base 1221. The atomization base 124 and the atomization tube base 1221 may be detachably connected to facilitate the assembly of the atomization device. For example, the side wall of the atomization base 124 is provided with a second snap-fitting position 1242, and the end of the atomization tube base 1221 facing the atomization base 124 is provided with a second snap-fitting portion 1225. The second snap-fitting portion 1225 engages with the second snap-fitting position 1242. The atomization base 124 is provided with an atomizer air inlet 1243. The atomizer air inlet 1243, the liquid-absorbing member 18, the inner liquid-conducting member 41, the inner tube 51, and the mouthpiece 114 are all in communication with each other.

The atomization device also includes a sealing plug 17 (also referred to as a mouthpiece plug). When the atomizer 1 is not in use, the sealing plug 17 seals the mouthpiece 114 to provide dust protection. During use, the sealing plug 17 is removed, and a user inhales through the mouthpiece 114. The airflow path is as indicated by the black arrows in FIG. 20. The atomization core assembly 12 also includes an electrode 1281, which is sheet-shaped. A portion of the electrode 1281 is fixed to the side wall of the atomization tube base 1221. Another portion of the electrode 1281, together with the heating element 123, is connected via leads to the electrode 1281 disposed at the end of the atomization tube base 1221 away from the atomization core assembly 12. The electrode 1281 is used to establish an electrical connection with the power supply board in the power supply assembly.

In yet another embodiment of the present application, an atomization device is provided, including a power supply assembly and the atomizer 1 described in the foregoing embodiments. The power supply assembly and the atomizer 1 are detachably connected. That is, the designed atomization device is a cartridge-replaceable type, allowing for the replacement of different atomizers 1—for instance, atomizers 1 containing matrices to be atomized with different flavors-thereby enhancing the practicality of the atomization device and enabling versatile application. The power supply assembly includes a power source and a power supply board. The power source is configured to supply electrical energy to the heating element 123, and the power supply board is configured to control the operational state of the heating element 123. Alternatively, in other embodiments, the atomization device may be designed for single use, wherein the power supply assembly and the atomizer 1 are fixedly connected.

The atomization core assembly 12 designed in the above embodiments of this application enables liquid injection into both the inner liquid-conducting member 41 and the outer liquid-conducting member 42. It is conducive to automated liquid filling, improves the production efficiency of the atomization core assembly 12, ensures consistency in the injected liquid volume, and facilitates quality control of the atomization core assembly 12. The designed atomization core assembly 12 can be used in both small-sized and large-sized atomization devices, with no specific limitations imposed in this application.

The atomizer 1 and the atomization device provided in the embodiments of this application include the atomization core assembly 12 as described in the above embodiments, and therefore share the same advantages. Thus, no further details are not provided here.

The above descriptions employ specific embodiments to illustrate the present disclosure, which are provided solely to facilitate understanding of the present disclosure and are not to be construed as limiting its scope. Those skilled in the art to which the present disclosure pertains may, guided by its principles, make various straightforward derivations, modifications, or substitutions.

1. An atomizer, comprising:
a housing, having a liquid storage chamber and a first mounting chamber therein, the liquid storage chamber being configured to store an atomization matrix;
an atomization core assembly, disposed within the first mounting chamber and configured to heat the atomization matrix to form an aerosol; and
a transition shell, at least a portion thereof being disposed within the housing and sleeved around the atomization core assembly;
wherein the atomizer is operable between an activated state and a inactivated state: in the activated state, the liquid storage chamber is in communication with the atomization core assembly; in the inactivated state, the liquid storage chamber is isolated from the atomization core assembly.

2. The atomizer according to claim 1, wherein:
the atomization core assembly comprises a liquid inlet;
the transition shell is configured to block or open the liquid inlet;
in the activated state, the liquid storage chamber is in communication with the liquid inlet; and
in the inactivated state, the liquid storage chamber is isolated from the liquid inlet.

3. The atomizer according to claim 2, wherein:
the transition shell is movable relative to the atomization core assembly, such that the liquid storage chamber is isolated from or in communication with the liquid inlet.

4. The atomizer according to claim 3, further comprising a driving member, wherein the driving member is connected with the transition shell and configured to drive the transition shell to move.

5. The atomizer according to claim 4, wherein:
the transition shell has a mounting portion;
the driving member comprises a connecting portion and a driving portion, wherein the driving portion is connected with the connecting portion, and an end of the connecting portion distal from the driving portion is detachably connected to the mounting portion;
the connecting portion is provided with a mounting groove, wherein the mounting portion is installed inside the mounting groove; the connecting portion has a frangible structure formed by: a recessed groove wall of the mounting groove facing away from the driving portion, and a recess at an end of the connecting portion distal from the driving portion extending toward the driving portion; a part of the mounting portion facing the frangible structure is provided with a piercing structure capable, under an external force, of breaking the frangible structure so as to disengage the connecting portion from the mounting portion.

6. The atomizer according to claim 3, further comprising a housing base, wherein at least a portion of the housing base is inserted in the housing and disposed on a side of the atomization core assembly;
the transition shell is disposed between the housing and the housing base;
the transition shell is provided with a first limiting portion, while the housing base is provided with a second limiting portion;
the first limiting portion and the second limiting portion engage in abutment.

7. The atomizer according to claim 3, further comprising a sealing top cover;
wherein the housing is provided with a mouthpiece in communication with the first mounting chamber;
the sealing top cover is disposed between the atomization core assembly and the first mounting chamber.

8. The atomizer according to claim 2, wherein
the atomization core assembly is axially movably inserted into the transition shell;
the atomization core assembly has, relative to the housing, a first mounted position and a second mounted position;
the atomization core assembly is switchable from the first mounted position to the second mounted position, so as to switch the atomizer from the inactivated state to the activated state.

9. The atomizer according to claim 8, wherein
the transition shell has a first positioning structure and a second positioning structure that are arranged at intervals along an axial direction of the housing;
the atomization core assembly is provided with a fixing structure configured to engage with both the first positioning structure and the second positioning structure;
when in the first mounted position, the fixing structure is engaged and secured with the first positioning structure, and the liquid inlet is sealed by the transition shell;
when in the second mounted position, the fixing structure is engaged and secured with the second positioning structure, and the liquid inlet is in communication with the liquid storage chamber.

10. The atomizer according to claim 9, further comprising an annular sealing member; wherein
the transition shell and the annular sealing member together form a core receptacle;
the transition shell is a cylindrical structure configured for fixed connection to the housing;
the annular sealing member is disposed at an end of the transition shell proximate to the liquid storage chamber;
the annular sealing member is made of an elastic material and is configured to isolate the liquid inlet from the liquid storage chamber.

11. The atomizer according to claim 1, wherein
the atomization core assembly comprises an inner liquid-conducting member, an outer liquid-conducting member, and an atomization bracket;
the outer liquid-conducting member is sleeved over an outer side of the inner liquid-conducting member;
the atomization bracket is divided axially into a first bracket segment and a second bracket segment;
the first bracket segment is sleeved between the inner liquid-conducting member and the outer liquid-conducting member;
the second bracket segment is provided with a liquid-filling port on a side adjacent to the first bracket segment, wherein the inner liquid-conducting member and the outer liquid-conducting member are in communication via the liquid-filling port;
in the activated state, the liquid storage chamber is in communication with the outer liquid-conducting member; and
in the inactivated state, the liquid storage chamber is isolated from the outer liquid-conducting member.

12. The atomizer according to claim 11, wherein
a side wall of the housing is provided with two first snap-fitting positions spaced apart axially;
an outer side wall of the transition shell is provided with a first snap-fitting portion;
wherein the first snap-fitting portion is configured to engage with the first snap-fitting positions at different axial locations so as to switch the atomizer between its different states.

13. An atomizer, comprising:
a housing, having a first end and a second end along its axial direction, wherein the first end is provided with an aerosol outlet, the housing comprises a transition shell disposed at the second end, the transition shell is provided with a first positioning structure and a second positioning structure spaced apart from each other along the axial direction of the housing; and
an atomization core assembly, axially movably engaged onto the transition shell; wherein the atomization core assembly, the transition shell, and the housing collectively enclose a liquid storage chamber; the atomization core assembly comprises an atomization tube provided with a liquid inlet capable of communicating with the liquid storage chamber; the atomization tube sealingly communicates with the aerosol outlet; the atomization core assembly is configured to heat an atomization matrix in the atomization tube to generate an aerosol; the atomization core assembly is provided with a fixing structure configured to engage with the first positioning structure and the second positioning structure;
wherein the atomization core assembly has a first mounted position and a second mounted position relative to the housing; when in the first mounted position, the fixing structure is engaged and secured with the first positioning structure, and the liquid inlet is sealed by the transition shell; when in the second mounted position, the fixing structure is engaged and secured with the second positioning structure, and the liquid inlet is in communication with the liquid storage chamber; the atomization core assembly is switchable from the first mounted position to the second mounted position.

14. An atomization device, comprising: an outer housing, a power supply assembly, and an atomizer according to claim 13; wherein:
the atomizer is disposed at an axial side of the outer housing,
the power supply assembly is movably disposed at an opposite axial side of the outer housing,
the atomization core assembly is disposed at a side of the atomizer adjacent to the power supply assembly,
the power supply assembly has a working position and a transitional position relative to the outer housing,
the power supply assembly is switchable from the transitional position to the working position, and during its movement from the transitional position to the working position, the power supply assembly abuts against and pushes the atomization core assembly, so as to move the atomization core assembly from the first mounted position to the second mounted position.

15. The atomization device according to claim 14, wherein
a side of the outer housing configured to receive the power supply assembly is provided with a third positioning structure and a fourth positioning structure that are axially spaced along the outer housing, the power supply assembly is provided with a locking structure configured to engage with both the third positioning structure and the fourth positioning structure;
when the power supply assembly is in the transitional position, the locking structure engages with the third positioning structure, thereby securing the power supply assembly in a position spaced apart from the atomization core assembly;
when the power supply assembly is in the working position, the locking structure engages with the fourth positioning structure, thereby securing the power supply assembly in a position where the atomization core assembly is in contact with the second mounted position.

16. The atomization device according to claim 14, wherein
the atomization core assembly comprises a circuit board disposed at an end of the atomization core assembly distal from the aerosol outlet,
the circuit board is configured to receive a voltage to control the atomization core assembly to heat the atomization matrix in the atomization tube,
a first electrical contact is provided on a side of the circuit board distal from the aerosol outlet;
the power supply assembly comprises a power supply board disposed at a side of the power supply assembly adjacent to the atomizer,
the power supply board is provided with a second electrical contact,
when the power supply assembly is in the working position, the second electrical contact engages with the first electrical contact to establish electrical conduction.
